(19) United States
(12) Patent Application Publication
(10) Pub. No.: US 2025/0049017 A1
(43) Pub. Date: Feb. 13, 2025

(54) LED TUBE OF MOSQUITO KILLER LAMP AND MOSQUITO KILLER LAMP

(71) Applicant: Meizhen LI, Shenzhen (CN)

(72) Inventor: Meizhen LI, Shenzhen (CN)

(21) Appl. No.: 18/483,494

(22) Filed: Oct. 9, 2023

Related U.S. Application Data
(63) Continuation of application No. 18/451,710, filed on Aug. 17, 2023.

(30) Foreign Application Priority Data
Aug. 7, 2023 (CN) 202322110455.6

(51) Int. Cl. A01M 1/04; A01M 1/22; F21S 9/03; F21V 23/02

(52) U.S. Cl. CPC A01M 1/04; A01M 1/223; F21S 9/03; F21V 23/02; F21Y 2115/10; H02J 7/0049; H02J 7/35

(57) ABSTRACT

The present disclosure discloses an LED tube of a mosquito killer lamp and a mosquito killer lamp. The LED tube includes a circuit board. The circuit board is provided with several LEDs; the LEDs adopt LEDs with a wavelength of 365 to 380 nm and LEDs with a wavelength of 380 to 400 nm. The LED tube further includes a scattering structure and a transparent tube body. The present disclosure also provides a mosquito killer lamp, which includes a power supplying module. The power supplying module configured to output a power supplying signal. A boost module electrically connected to the power supplying module and configured to receive the power supplying signal and output a boost driving signal. A mosquito killer unit is electrically connected to the boost module and a first light-emitting unit electrically connected to the power supplying module.

### CROSS-REFERENCE TO RELATED APPLICATIONS

This application is a Continuation of the U.S. application Ser. No. 18451710 filed on Aug. 17, 2023, and entitled “LED TUBE OF MOSQUITO KILLER LAMP AND MOSQUITO KILLER LAMP,” now pending, and also claims priority of Chinese patent application CN2023221104556, filed on Aug. 7, 2023, the entire disclosures of which are incorporated herein by reference.

### TECHNICAL FIELD

The present disclosure relates to the field of mosquito killer lamps, and particularly to a light-emitting diode (LED) tube of a mosquito killer lamp and a mosquito killer lamp.

### BACKGROUND

In our daily lives, mosquito killer lamps are widely used electronic products, which has many advantages compared to other mosquito products. A mosquito killer lamp neither has a pungent smell like mosquito-repellent incense and insecticides, nor causes chemical pollution, so the mosquito killer lamp is completely harmless to health. A working principle of the mosquito killer lamp is as follows: The mosquito killer lamp lures mosquitoes to get close to a light source using mosquito's tendency toward light and then kills the mosquitoes through an electric mesh around the light source. The mosquito killer lamp has unique features of silence and odorlessness, and would not cause any harm to human. At present, common mosquito killer lamps on the market mainly use an ultraviolet technology. However, the traditional ultraviolet mosquito killer lamp has high power consumption and is not environmentally-friendly. Therefore, there is an urgent need for a more energy-saving and environmentally-friendly mosquito killer lamp product.

### SUMMARY

In view of this, the present disclosure provides an LED tube of a mosquito killer lamp and a mosquito killer lamp, so that the mosquito killer lamp saves more power and is favorable for environmental protection.

The present disclosure discloses a light-emitting diode (LED) tube of a mosquito killer lamp, including an LED tube, wherein the LED tube is configured to receive a power supplying signal sent by a power supplying module and emit light for luring mosquitoes.

As the improvement of the present disclosure, the LED tube includes a circuit board; the circuit board is provided with several LEDs; one end of the circuit board is connected with an electrifying device; the electrifying device is connected with a first end cover; a pin is mounted on the first end cover; the pin is electrically connected to the electrifying device; and the other end of the circuit board is connected with a second end cover.

As the improvement of the present disclosure, the LED tube further includes a scattering structure and a transparent tube body; one end of the scattering structure is connected to the first end cover; the other end of the scattering structure is connected to the second end cover; one end of the transparent tube body is connected to the first end cover; and the other end of the transparent tube body is connected to the second end cover.

As the improvement of the present disclosure, the several LEDs are irregularly arranged on the circuit board; and the LEDs adopt LEDs with a wavelength of 365 to 380 nm and LEDs with a wavelength of 380 to 400 nm.

The present disclosure also provides a mosquito killer lamp, including:
a power supplying module, configured to output a power supplying signal;
a boost module, electrically connected to the power supplying module and configured to receive the power supplying signal and output a boost driving signal;
a mosquito killer unit, wherein the mosquito killer unit is electrically connected to the boost module and is configured to receive the driving signal, so that the mosquito killer unit kills mosquitoes; and
a first light-emitting unit, electrically connected to the power supplying module and configured to receive the power supplying signal, wherein the first light-emitting unit includes an LED tube; and the LED tube is configured to emit light luring mosquitoes.

As the improvement of the present disclosure, the power supplying module includes a first main control chip and a charging circuit; the charging circuit is electrically connected to an external power supply and a battery, and is configured to receive an external supply voltage and a battery voltage; the charging circuit is electrically connected to the first main control chip; a first output end of the charging circuit is configured to output an external power supply charging signal; a second output end of the charging circuit is configured to output a battery charging signal; a first control end of the charging circuit is configured to output a charging control signal; and the first main control chip charges the mosquito killer lamp according to the received charging control signal and the external power supply charging signal or the battery charging signal.

As the improvement of the present disclosure, the power supplying module includes a switching circuit; the switching circuit is electrically connected to the charging circuit and the first main control chip; the switching circuit is configured to receive the external supply voltage and the battery voltage and output a supply voltage; the first main control chip is configured to receive the supply voltage; and when the charging circuit receives the external supply voltage, the switching circuit switches off inputting of the battery voltage of the charging circuit, so that when the external power supply performs charging, the battery stops supplying power.

As the improvement of the present disclosure, the power supplying module includes a solar circuit and a solar panel electrically connected to the solar circuit; the solar panel is configured to absorb solar rays and convert the solar rays into electric energy through the solar circuit; the solar circuit is electrically connected to the first main control chip and the battery to output a solar charging signal to the first main control chip and charge the battery; and after the battery is fully charged, the first main control chip outputs a stop signal to control the solar circuit to stop charging.

As the improvement of the present disclosure, the mosquito killer lamp further includes a second light-emitting unit; the second light-emitting unit includes a second light-emitting driving circuit; the second light-emitting driving circuit is electrically connected to the first main control chip to receive a working voltage and second control signal output by the first main control chip; and the second light-emitting unit is configured to achieve lighting.

As the improvement of the present disclosure, the power supplying module further includes a load switch circuit; the load switch circuit is electrically connected to the boost module, the first light-emitting unit, and the first main control chip; the load switch circuit is configured to receive a turn-on signal of the first main control chip and output a power supplying signal to the first light-emitting unit and the boost module respectively.

As the improvement of the present disclosure, the first light-emitting unit includes a first light-emitting driving circuit; the first light-emitting driving circuit is electrically connected to the LED tube; and the first light-emitting driving circuit is electrically connected to the load switch circuit and the first main control chip to receive the power supplying signal input by the load switch circuit and the first control signal input by the first main control chip and output a driving signal to drive the LED tube to emit light.

As the improvement of the present disclosure, the mosquito killer lamp further includes an input protection circuit, wherein the input protection circuit is electrically connected to the external power supply and the charging circuit, and is configured to output the external supply voltage to the charging circuit; the input protection circuit is configured to protect the charging circuit; the charging circuit further includes an indicator lamp module; and the indicator lamp module is electrically connected to the first main control chip and is configured to receive the working voltage of the first main control chip and display whether the charging circuit is in a normal working state.

As the improvement of the present disclosure, the mosquito killer lamp further includes a stepless adjustment circuit, wherein the stepless adjustment circuit includes a stepless adjustment device and a second main control chip; the stepless adjustment device is electrically connected to the second main control chip, and the second main control chip is electrically connected to the first main control chip; the stepless adjustment device is configured to perform a user operation to generate a wavelength adjustment signal and a brightness adjustment signal within a preset adjustment range; and the second main control chip is configured to receive the wavelength adjustment signal and the brightness adjustment signal and output an adjustment signal to the first main control chip, so that the first main control chip outputs a first control signal and a second control signal according to the adjustment signal, and the first light-emitting unit and the second light-emitting unit emit light within the preset adjustment range.

As the improvement of the present disclosure, the mosquito killer lamp further includes a light detection module, wherein the light detection module includes a photoresistor and a resistance switch; the photoresistor is electrically connected to the first main control chip; the photoresistor is configured to receive a power signal output by the first main control chip, and the resistance switch is electrically connected to the second main control chip; when the resistance switch is turned on and the photoresistor detects corresponding light changes and reaches a preset resistance value, the photoresistor outputs a detection signal; and the first main control chip receives the detection signal and controls the mosquito killer lamp to be turned on.

As the improvement of the present disclosure, the mosquito killer unit includes a high-voltage power grid; the high-voltage power grid is configured to kill, under a high voltage, mosquitoes lured by the first light-emitting unit; the mosquito killer unit further includes a circuit board; the first main control chip, the charging circuit, the first light-emitting driving circuit, the switching circuit, the load switch circuit, the solar circuit, the input protection circuit, the stepless adjustment circuit, and the light detection module are all installed on the circuit board; the mosquito killer lamp further includes a mounting shell; and the mounting shell is connected to the high-voltage power grid, the battery, the LED tube, and the circuit board.

As the improvement of the present disclosure, the LED tube includes a circuit board; the circuit board is provided with several LEDs; one end of the circuit board is connected with an electrifying device; the electrifying device is connected with a first end cover; a pin is mounted on the first end cover; the pin is electrically connected to the electrifying device; and the other end of the circuit board is connected with a second end cover.

As the improvement of the present disclosure, the LED tube further includes a scattering structure and a transparent tube body; one end of the scattering structure is connected to the first end cover; the other end of the scattering structure is connected to the second end cover; one end of the transparent tube body is connected to the first end cover; the other end of the transparent tube body is connected to the second end cover; the several LEDs are irregularly arranged on the circuit board; and the LEDs adopt LEDs with a wavelength of 365 to 380 nm and LEDs with a wavelength of 380 to 400 nm.

As the improvement of the present disclosure, the LED tube is detachably connected to the mounting shell; the mounting shell includes an upper shell and a base; the upper shell is provided with a first clamping slot and a first fixing member; the first fixing member is provided with a mounting hole; the pin is detachably plugged into the mounting hole; the first end cover is detachably plugged into the first clamping slot; the base is provided with a second clamping slot and a second fixing member; and the second end cover is detachably plugged into the second clamping slot through the second fixing member.

As the improvement of the present disclosure, the mosquito killer lamp further includes a lampshade, wherein an upper end of the lampshade is connected to a bottom of the upper shell, and a lower end is connected to a top of the base; the LED tube and the high-voltage power grid are both arranged in the lampshade; the high-voltage power grid is arranged around the LED tube; one end of the high-voltage power grid is connected to the upper shell, and the other end of the high-voltage power grid is connected to the base; the base is provided with a killed mosquito opening and a bottom cover; the bottom cover is detachably connected to the base; when the high-voltage power grid kills mosquitoes, the mosquitoes killed by the high-voltage power grid enter and fall onto the bottom cover through the killed mosquito opening.

As the improvement of the present disclosure, the mosquito killer lamp an upper end surface of the mounting shell is provided with a first solar panel; the first solar panel is electrically connected to the circuit board; the mounting shell is provided with a cover body; the cover body is rotatably connected to the mounting shell; the cover body is provided with a second solar panel; the second solar panel is electrically connected to the circuit board; the second light-emitting unit of the mosquito killer lamp includes several LEDs; the LEDs are arranged around the upper shell; the upper shell is further provided with a transparent cover body; the transparent cover body covers the LEDs; the mosquito killer lamp further includes a handle portion; the handle portion is rotatably connected to the mounting shell; and the handle portion is configured to carry the mosquito killer lamp.

Beneficial effects: the present disclosure discloses an LED tube of a mosquito killer lamp and a mosquito killer lamp. The LED tube includes a circuit board. The circuit board is provided with several LEDs; the LEDs adopt LEDs with a wavelength of 365 to 380 nm and LEDs with a wavelength of 380 to 400 nm. The LED tube further includes a scattering structure and a transparent tube body. The present disclosure also provides a mosquito killer lamp, which includes a power supplying module. The power supplying module configured to output a power supplying signal. A boost module electrically connected to the power supplying module and configured to receive the power supplying signal and output a boost driving signal. A mosquito killer unit is electrically connected to the boost module and is configured to receive the driving signal to kill mosquitoes and a first light-emitting unit electrically connected to the power supplying module and configured to receive the power supplying signal. The first light-emitting unit includes an LED tube. The LED tube is configured to emit light luring mosquitoes. Through the arrangement of the above structure, so that the mosquito killer lamp saves more power and is favorable for environmental protection.

### BRIEF DESCRIPTION OF THE DRAWINGS

In order to explain the technical solutions of the embodiments of the present disclosure more clearly, the following will briefly introduce the accompanying drawings used in the embodiments. Apparently, the drawings in the following description are only some embodiments of the present disclosure. Those of ordinary skill in the art can obtain other drawings based on these drawings without creative work.

FIG. 1 is an overall structural diagram of an LED tube of a mosquito killer lamp of the present disclosure;

FIG. 2 is an exploded diagram of an LED tube of a mosquito killer lamp of the present disclosure;

FIG. 3 is an overall structural diagram of a mosquito killer lamp of the present disclosure;

FIG. 4 is an exploded diagram of a mosquito killer lamp of the present disclosure;

FIG. 5 is an exploded diagram of an upper shell and a base of a mosquito killer lamp of the present disclosure;

FIG. 6 is a sectional diagram of a mosquito killer lamp of the present disclosure;

FIG. 7 is an exploded diagram of a solar panel according to one embodiment of a mosquito killer lamp of the present disclosure;

FIG. 8 is an exploded diagram of a solar panel according to another embodiment of a mosquito killer lamp of the present disclosure;

FIG. 9 is an exploded diagram of a solar panel according to another embodiment of a mosquito killer lamp of the present disclosure;

FIG. 10 is an exploded diagram of a solar panel according to another embodiment of a mosquito killer lamp of the present disclosure;

FIG. 11 is an overall circuit diagram of a mosquito killer lamp of the present disclosure;

FIG. 12 is a circuit diagram of a first main control chip of a mosquito killer lamp of the present disclosure;

FIG. 13 is a circuit diagram of a first light-emitting driving circuit of a mosquito killer lamp of the present disclosure;

FIG. 14 is a circuit diagram of a boost module and a mosquito killer unit of a mosquito killer lamp of the present disclosure;

FIG. 15 is a circuit diagram of a charging circuit of a mosquito killer lamp of the present disclosure;

FIG. 16 is a circuit diagram of a second light-emitting driving circuit of a mosquito killer lamp of the present disclosure;

FIG. 17 is a circuit diagram of a switching circuit of a mosquito killer lamp of the present disclosure;

FIG. 18 is a circuit diagram of a solar charging circuit of a mosquito killer lamp of the present disclosure;

FIG. 19 is a circuit diagram of a load switch circuit of a mosquito killer lamp of the present disclosure;

FIG. 20 is a circuit diagram of an input protection circuit of a mosquito killer lamp of the present disclosure;

FIG. 21 is a circuit diagram of a stepless adjustment circuit of a mosquito killer lamp of the present disclosure; and

FIG. 22 is a circuit diagram of a light detection circuit of a mosquito killer lamp of the present disclosure.

### DETAILED DESCRIPTION OF THE EMBODIMENTS

In order to make the aim, technical scheme and advantages of the invention clearer, the following will be combined with the accompanying drawings of embodiments of the present disclosure, The technical scheme in the embodiment of the invention is clearly and completely described, Obviously, the described embodiments are part of the embodiments of the present disclosure, and not all embodiments are based on the embodiments of the present disclosure, and all other embodiments attained by those of ordinary skill in the art without inventive effort are within the scope of the present disclosure.

The terms “first”, “second” and “third” in the specification and claim of the present disclosure and the attached drawings are used to distinguish different objects rather than to describe a specific sequence. Furthermore, the term “includes”, and any variation thereof, is intended to cover non-exclusive inclusion. For example, a process, method, system, product or device comprising a series of steps or units is not limited to the listed steps or units, but optionally also includes steps or units not listed, or optionally includes other steps or units inherent to those processes, methods, products or devices.

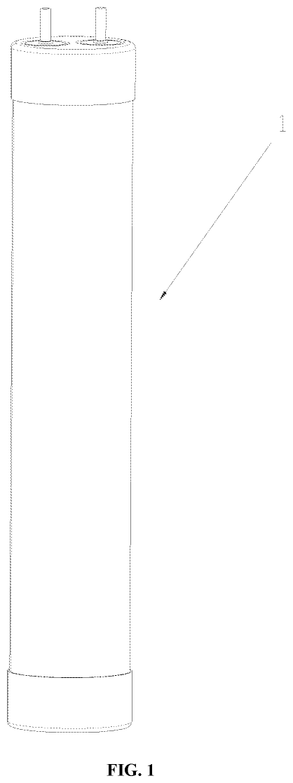

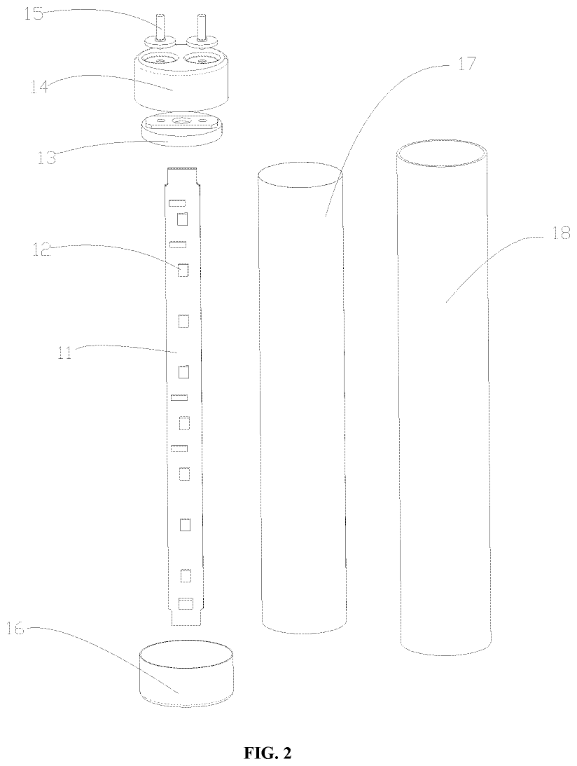

Referring to FIG. 1 to FIG. 2, an LED tube 1 of a mosquito killer lamp includes an LED tube 1. The LED tube 1 is configured to receive a power supplying signal VDDO sent by a power supplying module 2 and emit light for luring mosquitoes. By means of the above structure, compared with a traditional incandescent lamp or fluorescent lamp, the LED tube 1 has higher energy conversion efficiency. An LED lamp consumes less energy in the process of generating light and consumes less power, reducing the demand for energy, thus causing less burden on the environment.

In this embodiment, the LED tube 1 includes a circuit board 11; the circuit board 11 is provided with several LEDs 12; one end of the circuit board 11 is connected with an electrifying device 13; the electrifying device 13 is connected with a first end cover 14; a pin 15 is mounted on the first end cover 14; the pin 15 is electrically connected to the electrifying device 13; and the other end of the circuit board 11 is connected with a second end cover 16.

In this embodiment, the LED tube 1 further includes a scattering structure 17 and a transparent tube body 18; one end of the scattering structure 17 is connected to the first end cover 14; the other end of the scattering structure 17 is connected to the second end cover 16; one end of the transparent tube body 18 is connected to the first end cover 14; and the other end of the transparent tube body 18 is connected to the second end cover 16.

In this embodiment, the several LEDs 12 are irregularly arranged on the circuit board 11; and the LEDs 12 adopt LEDs with a wavelength of 365 to 380 nm and LEDs with a wavelength of 380 to 400 nm. Preferably, the wavelength can be adjusted to 369 mm to kill mosquitoes and 395 mm to kill insects such as moths. By means of the above structure, light with different wavelengths can attract different insects and kill mosquitoes or moths separately. By combining light sources with different wavelengths, the attraction and insecticidal effect of the mosquito killer lamp can be increased, while unnecessary harm to beneficial insects can be avoided.

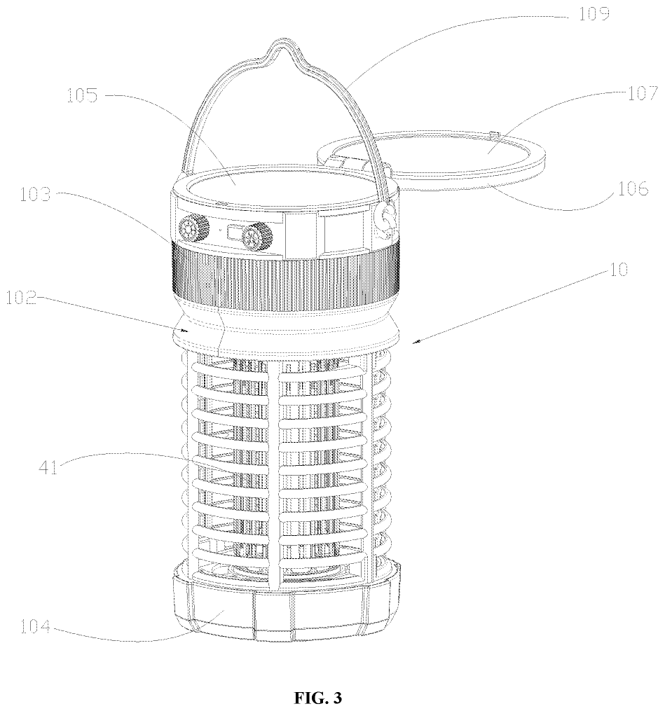

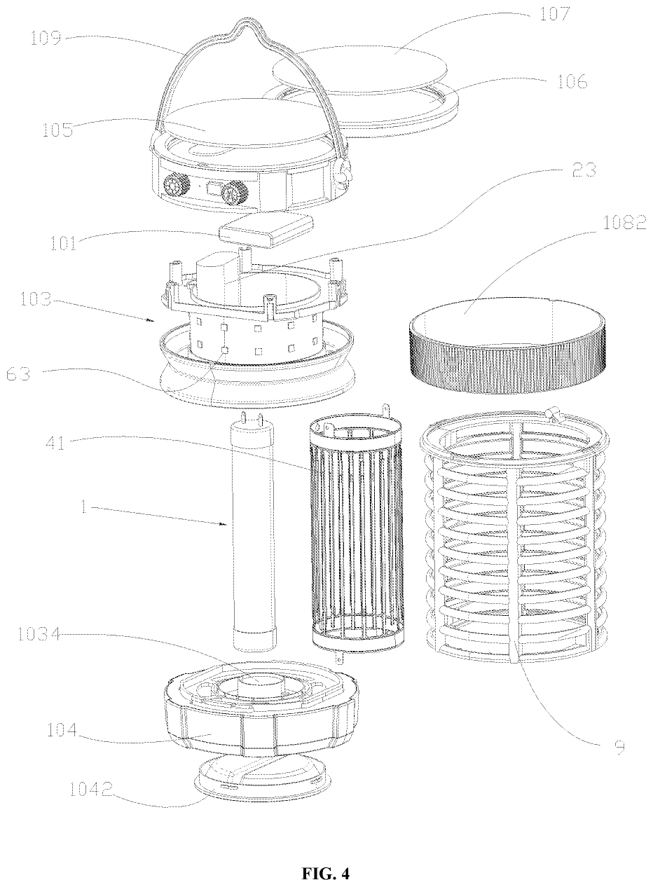

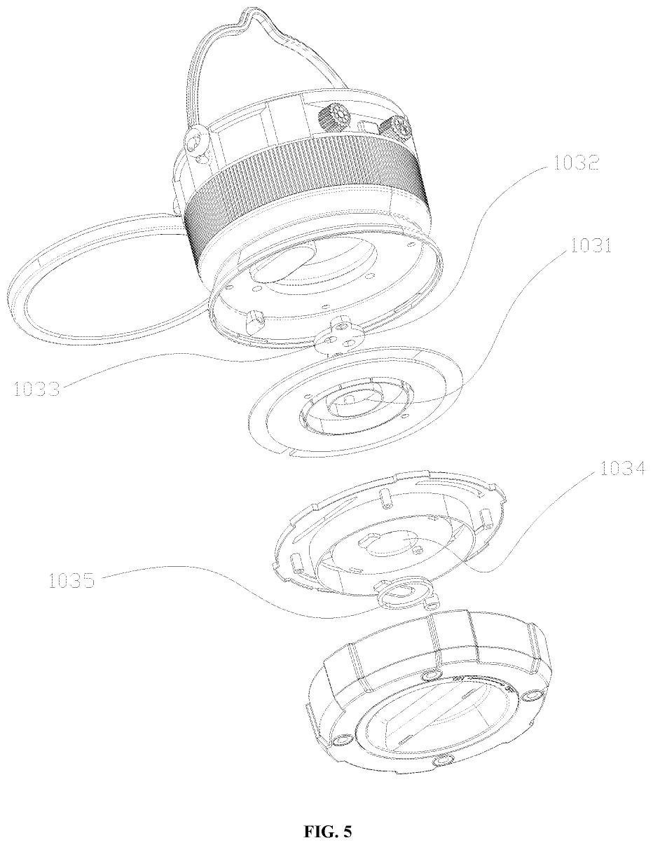

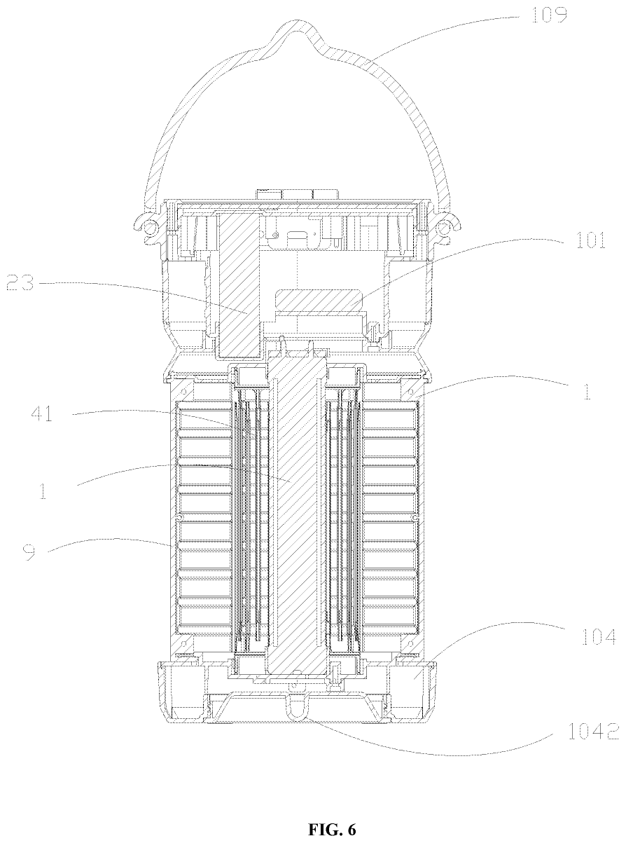

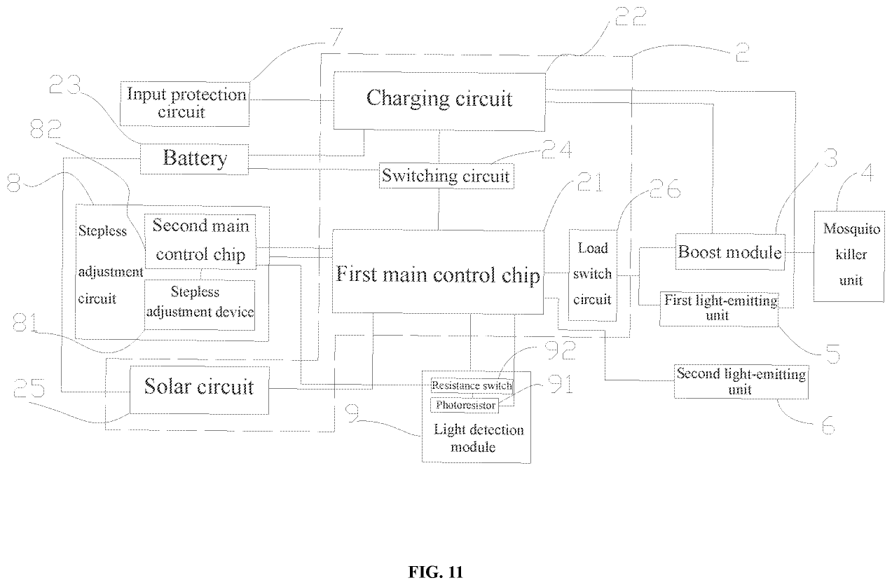

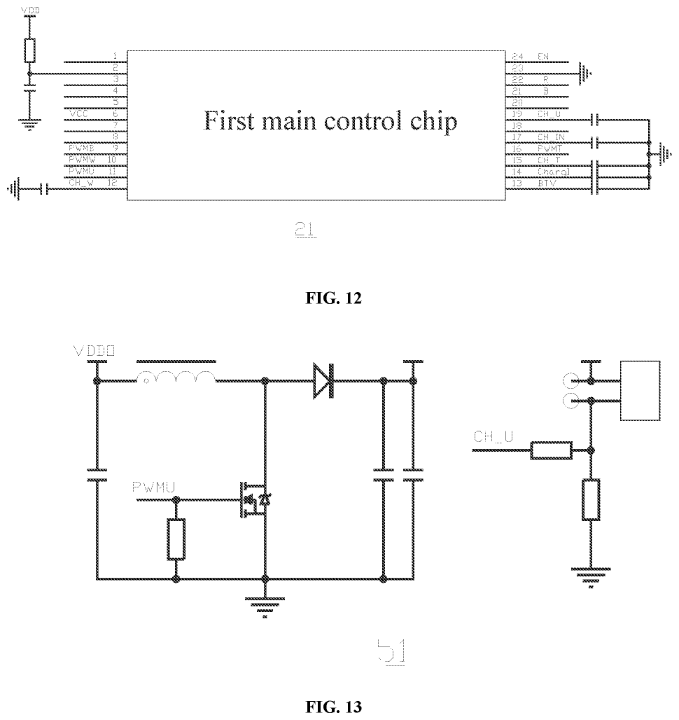

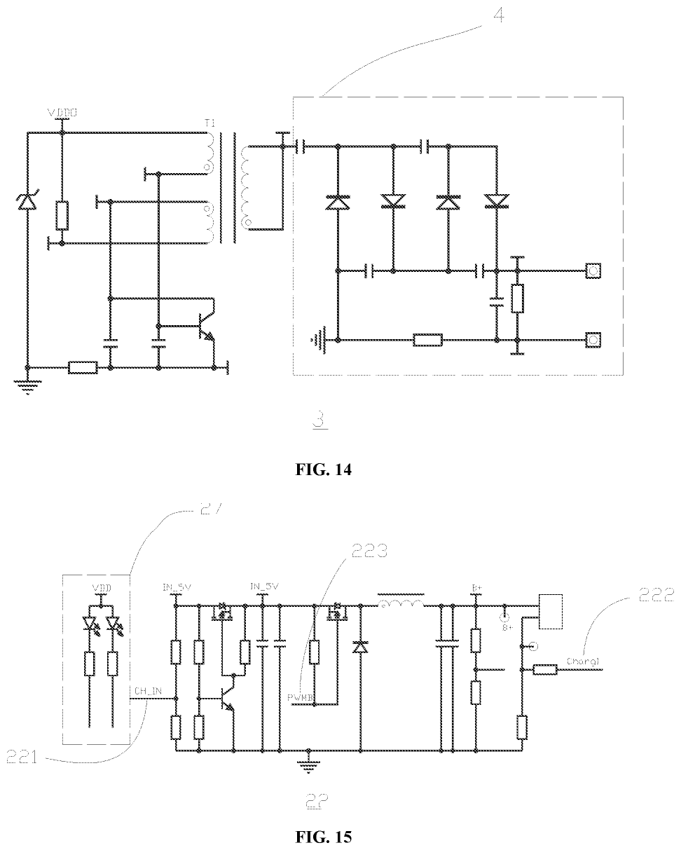

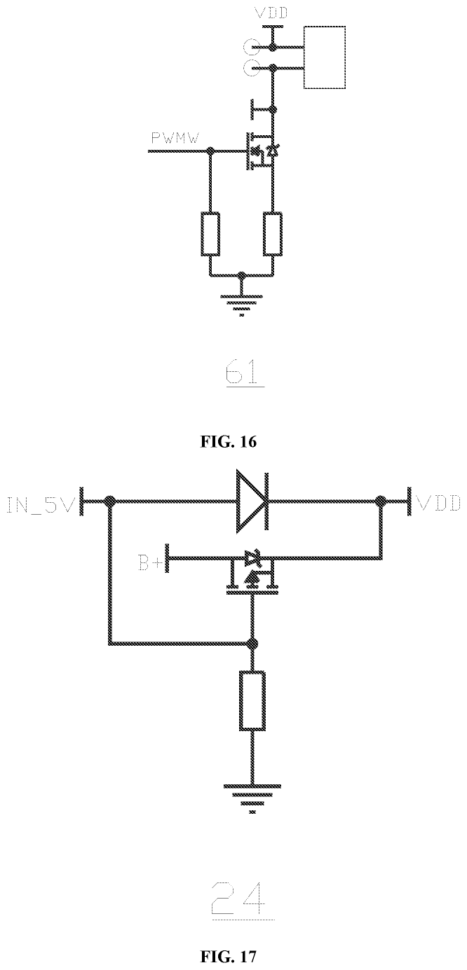

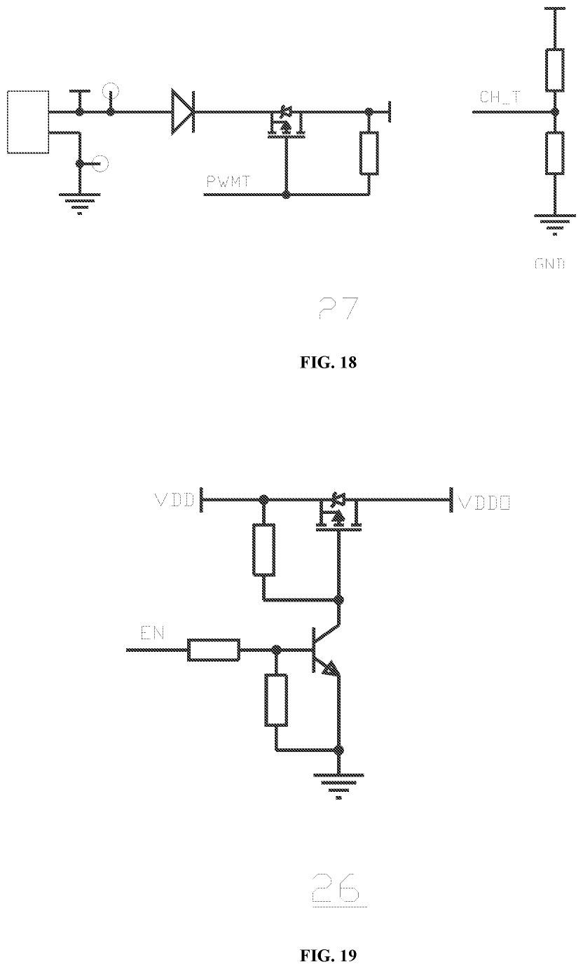

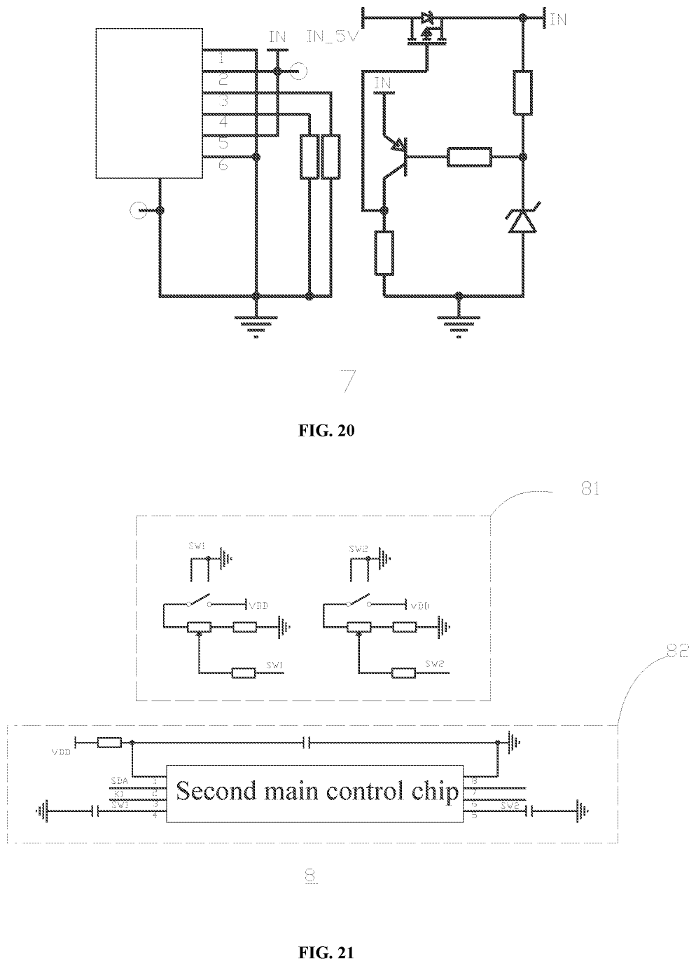

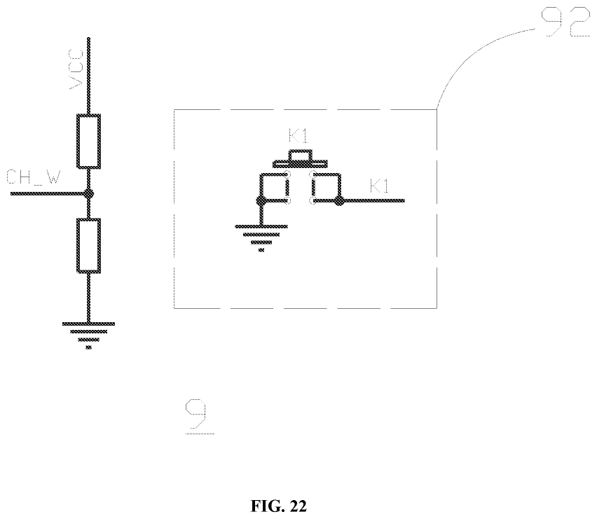

Referring to FIG. 1 to FIG. 22, a mosquito killer lamp includes a power supplying module 2, configured to output a power supplying signal VDDO; a boost module 3, electrically connected to the power supplying module 2 and configured to receive the power supplying signal VDDO and output a boost driving signal T1; a mosquito killer unit 4, wherein the mosquito killer unit 4 is electrically connected to the boost module 3 and is configured to receive the driving signal T1 to kill mosquitoes; and a first light-emitting unit 5, electrically connected to the power supplying module 2 and configured to receive the power supplying signal VDDO. The first light-emitting unit 5 includes an LED tube 1. The LED tube 1 is configured to emit light luring mosquitoes.

In this embodiment, the power supplying module 2 includes a first main control chip 21 and a charging circuit 22; the charging circuit 22 is electrically connected to an external power supply and a battery 23, and is configured to receive an external supply voltage IN_5V and a battery voltage B+; the charging circuit 22 is electrically connected to the first main control chip 21; a first output end 221 of the charging circuit 22 is configured to output an external power supply charging signal CH_IN; a second output end 222 of the charging circuit is configured to output a battery charging signal CHargI; a first control end 223 of the charging circuit 22 is configured to output a charging control signal PWMB; and the first main control chip 21 charges the mosquito killer lamp 10 according to the received charging control signal PWMB and the external power supply charging signal CH_IN or the battery charging signal CHargI.

In this embodiment, the power supplying module 2 includes a switching circuit 24; the switching circuit 24 is electrically connected to the charging circuit 22 and the first main control chip 21; the switching circuit 24 is configured to receive the external supply voltage IN_5V and the battery voltage B+ and output a supply voltage VDD; the first main control chip 21 is configured to receive the supply voltage VDD; and when the charging circuit 22 receives the external supply voltage IN_5V, the switching circuit 24 switches off inputting of the battery voltage B+ of the charging circuit 22, so that when the external power supply performs charging, the battery 23 stops supplying power.

In this embodiment, the power supplying module 2 includes a solar circuit 25 and a solar panel 105 (107) electrically connected to the solar circuit 25; the solar panel 105 (107) is configured to absorb solar rays and convert the solar rays into electric energy through the solar circuit 25; the solar circuit 25 is electrically connected to the first main control chip 21 and the battery 23 to output a solar charging signal PWMT to the first main control chip 21 and charge the battery 23; and after the battery 23 is fully charged, the first main control chip 21 outputs a stop signal CH_T to control the solar circuit 25 to stop charging.

In this embodiment, the mosquito killer lamp further includes a second light-emitting unit 6; the second light-emitting unit 6 includes a second light-emitting driving circuit 61; the second light-emitting driving circuit 61 is electrically connected to the first main control chip 21 to receive a working voltage VDD and second control signal PWMW output by the first main control chip 21; and the second light-emitting unit 6 is configured to achieve lighting.

In this embodiment, the power supplying module 2 further includes a load switch circuit 26; the load switch circuit 26 is electrically connected to the boost module 3, the first light-emitting unit 5, and the first main control chip 21; the load switch circuit 26 is configured to receive a turn-on signal EN of the first main control chip 21 and output a power supplying signal VDDO to the first light-emitting unit 5 and the boost module 3 respectively.

In this embodiment, the first light-emitting unit 5 includes a first light-emitting driving circuit 51; the first light-emitting driving circuit 51 is electrically connected to the LED tube 1; and the first light-emitting driving circuit 51 is electrically connected to the load switch circuit 26 and the first main control chip 21 to receive the power supplying signal VDDO input by the load switch circuit 26 and the first control signal PWMU input by the first main control chip 21 and output a driving signal CH_U to drive the LED tube 1 to emit light.

In this embodiment, the mosquito killer lamp further includes an input protection circuit 7; the input protection circuit 7 is electrically connected to the external power supply and the charging circuit 22, and is configured to output the external supply voltage IN_5V to the charging circuit 22; the input protection circuit 7 is configured to protect the charging circuit 22; the charging circuit 22 further includes an indicator lamp module 27; and the indicator lamp module 27 is electrically connected to the first main control chip 21 and is configured to receive the working voltage VDD of the first main control chip 21 and display whether the charging circuit 22 is in a normal working state.

In this embodiment, the mosquito killer lamp further includes a stepless adjustment circuit 8; the stepless adjustment circuit 8 includes a stepless adjustment device 81 and a second main control chip 82; the stepless adjustment device 81 is electrically connected to the second main control chip 82, and the second main control chip 82 is electrically connected to the first main control chip 21; the stepless adjustment device 81 is configured to perform a user operation to generate a wavelength adjustment signal SW1 and a brightness adjustment signal SW2 within a preset adjustment range; and the second main control chip 82 is configured to receive the wavelength adjustment signal SW1 and the brightness adjustment signal SW2 and output an adjustment signal SDA to the first main control chip 21, so that the first main control chip 21 outputs a first control signal PWMU and a second control signal PWMW according to the adjustment signal SDA, and the first light-emitting unit 5 and the second light-emitting unit 6 emit light within the preset adjustment range.

In this embodiment, the mosquito killer lamp further includes a light detection module 9; the light detection module 9 includes a photoresistor 91 and a resistance switch 92 (K1); the photoresistor 91 is electrically connected to the first main control chip 21; the photoresistor 91 is configured to receive a power signal VCC output by the first main control chip 21, and the resistance switch 92 is electrically connected to the second main control chip 82; when the resistance switch 92 is turned on and the photoresistor 91 detects corresponding light changes and reaches a preset resistance value, the photoresistor 91 outputs a detection signal CH_W; and the first main control chip 21 receives the detection signal CH_W and controls the mosquito killer lamp 10 to be turned on. By means of the above structure, mosquitoes move more frequently at night or in a dim environment, so the mosquito killer lamp needs to play a role at night or in the dim environment. When the resistance switch 92 is turned on, the photoresistor 91 can sense the intensity of the ambient light and automatically turn on the mosquito killer lamp according to changes of light. In low light, the mosquito killer lamp will be automatically turned on. In high light, the mosquito killer lamp will be turned off, to save energy and reduce unnecessary interference.

In this embodiment, the mosquito killer unit 4 includes a high-voltage power grid 41; the high-voltage power grid 41 is configured to kill, under a high voltage, mosquitoes lured by the first light-emitting unit 5; the mosquito killer unit further includes a circuit board 101; the first main control chip 21, the charging circuit 22, the first light-emitting driving circuit 51, the switching circuit 24, the load switch circuit 26, the solar circuit 25, the input protection circuit 7, the stepless adjustment circuit 8, and the light detection module 9 are all installed on the circuit board 101; the mosquito killer lamp 10 further includes a mounting shell 102; and the mounting shell 102 is connected to the high-voltage power grid 41, the battery 23, the LED tube 1, and the circuit board 101.

In this embodiment, the LED tube 1 includes a circuit board 11; the circuit board 11 is provided with several LEDs 12; one end of the circuit board 11 is connected with an electrifying device 13; the electrifying device 13 is connected with a first end cover 14; a pin 15 is mounted on the first end cover 14; the pin 15 is electrically connected to the electrifying device 13; and the other end of the circuit board 11 is connected with a second end cover 16.

In this embodiment, the LED tube 1 further includes a scattering structure 17 and a transparent tube body 18; one end of the scattering structure 17 is connected to the first end cover 14; the other end of the scattering structure 17 is connected to the second end cover 16; one end of the transparent tube body 18 is connected to the first end cover 14; the other end of the transparent tube body 18 is connected to the second end cover 16; the several LEDs 12 are irregularly arranged on the circuit board 11; and the LEDs 12 adopt LEDs 11 with a wavelength of 365 to 380 nm and LEDs with a wavelength of 380 to 400 nm. Further, the scattering structure 17 is a frosted material structure or a frosted glass material structure. By means of the above structure, the lighting effect of the LED tube can be improved, and the dazzling sensation is relieved, so that light for illumination is more comfortable and warmer.

In this embodiment, the LED tube 1 is detachably connected to the mounting shell 102; the mounting shell 102 includes an upper shell 103 and a base 104; the upper shell 103 is provided with a first clamping slot 1031 and a first fixing member 1032; the first fixing member 1032 is provided with a mounting hole 1033; the pin 15 is detachably plugged into the mounting hole 1033; the first end cover 14 is detachably plugged into the first clamping slot 1031; the base is provided with a second clamping slot 1034 and a second fixing member 1035; and the second end cover 16 is detachably plugged into the second clamping slot 1034 through the second fixing member 1035.

In this embodiment, the mosquito killer lamp further includes a lampshade 9; an upper end of the lampshade 9 is connected to a bottom of the upper shell 103, and a lower end is connected to a top of the base 104; and the LED tube 1 and the high-voltage power grid 41 are both arranged in the lampshade 9. The lampshade 9 is a grid hollow lampshade 9. During use by a user, the grid lampshade 9 can cause mosquitoes to enter the high-voltage power grid 41 and be killed and can also prevent mistouch of the high-voltage power grid 41 caused by the fact that the user accidentally sticks a finger into the lampshade 9. The high-voltage power grid 41 is arranged around the LED tube 1; one end of the high-voltage power grid 41 is connected to the upper shell 103, and the other end of the high-voltage power grid 41 is connected to the base 104; the base 104 is provided with a killed mosquito opening 1041 and a bottom cover 1042; the bottom cover 1042 is detachably connected to the base 104; when the high-voltage power grid 41 kills mosquitoes, the mosquitoes killed by the high-voltage power grid 41 enter and fall onto the bottom cover 1042 through the killed mosquito opening 1041. By means of the above structure, when in use, the mosquitoes that have been killed by the high-voltage power grid 41 will fall into the bottom cover 1042 from the high-voltage power grid 41, so as to prevent the mosquitoes from directly falling onto the ground. To clean mosquitoes, the bottom cover 1042 can be removed from the base 104 to clean the mosquitoes in the bottom cover 1042, which is easy to clean and convenient to use. This solves the technical problem that when the traditional mosquito killer lamp is used, mosquito bodies fall onto the ground and are difficult to intensively clean.

In this embodiment, an upper end surface of the mounting shell 102 is provided with a first solar panel 105; the first solar panel 105 is electrically connected to the circuit board 101; the mounting shell 102 is provided with a cover body 106; the cover body 106 is rotatably connected to the mounting shell 102; the cover body 106 is provided with a second solar panel 107; and the second solar panel 107 is electrically connected to the circuit board 101. By means of the above structure, the first solar panel 105 and the second solar panel 107 can be designed to use solar energy for charging during the day. A storage battery will store electric energy, which saves energy. Even in the event of a power outage or power failure, the mosquito killer lamp 10 can continue to operate, enhancing the reliability and continuity of the mosquito killer lamp 10.

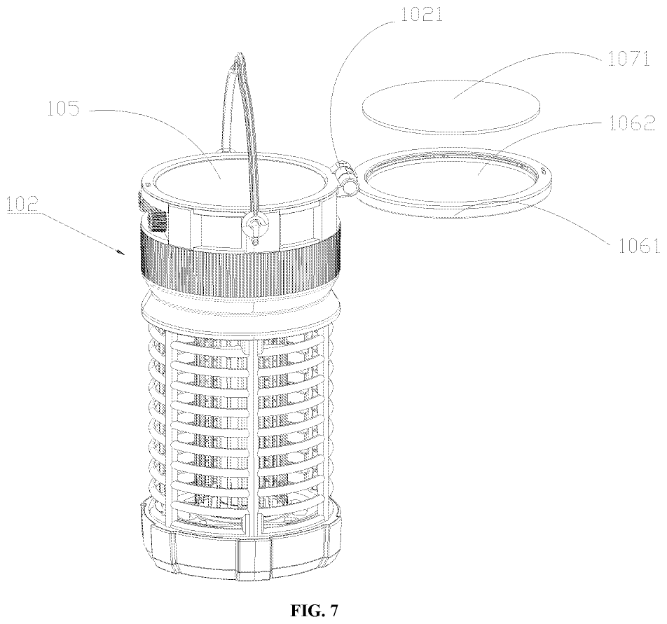

Referring to FIG. 7, the cover body 106 includes a first cover body 1061; the first cover body 1061 can be flipped and rotated with the mounting shell 102 through a first rotating shaft mechanism 1021. The first rotating shaft mechanism 1021 is horizontally arranged between the first cover body 1061 and the mounting shell 102, and the first cover body 1061 is flipped up and down to cover the upper end face of the mounting shell 102 through the first rotating shaft mechanism 1021. The first cover body 1061 is provided with a third accommodating slot 1062; the second solar panel 107 includes a third solar panel 1071; the third solar panel 1071 is arranged in the third accommodating slot 1062; and when the first cover body 1061 is flipped to open, the first solar panel 105 and the second solar panel 107 can work simultaneously.

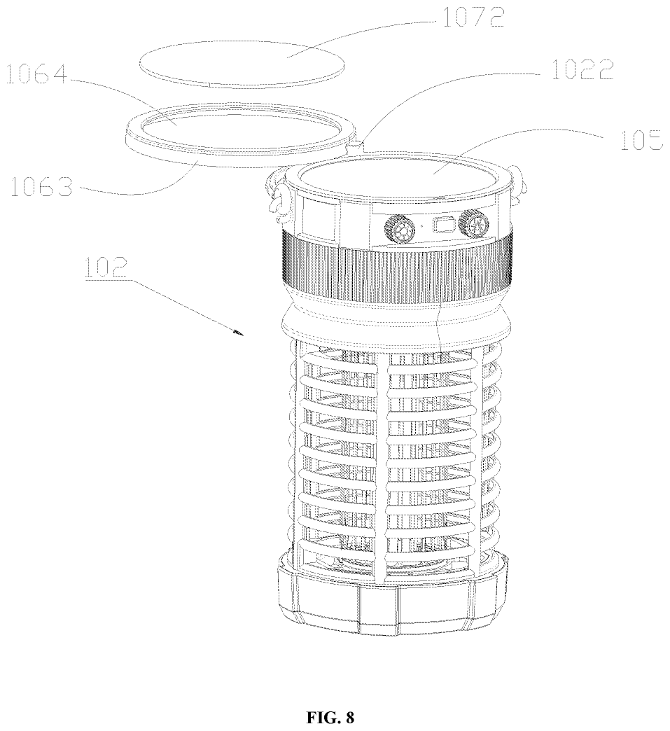

Referring to FIG. 8, the cover body 106 includes a second cover body 1063; the second cover body 1063 can be rotatably connected to the mounting shell 102 through a second rotating shaft mechanism 1022. The second rotating shaft mechanism 1022 is vertically arranged between the second cover body 1063 and the mounting shell 102, and the second cover body 1063 slides left and right to cover the upper end face of the mounting shell 102 through the second rotating shaft mechanism 1022. The second cover body 1063 is provided with a fourth accommodating slot 1064; the second solar panel 107 includes a fourth solar panel 1072; the fourth solar panel 1072 is arranged in the fourth accommodating slot 1064; and when the second cover body 1063 slides to open, the first solar panel 105 and the second solar panel 107 can work simultaneously.

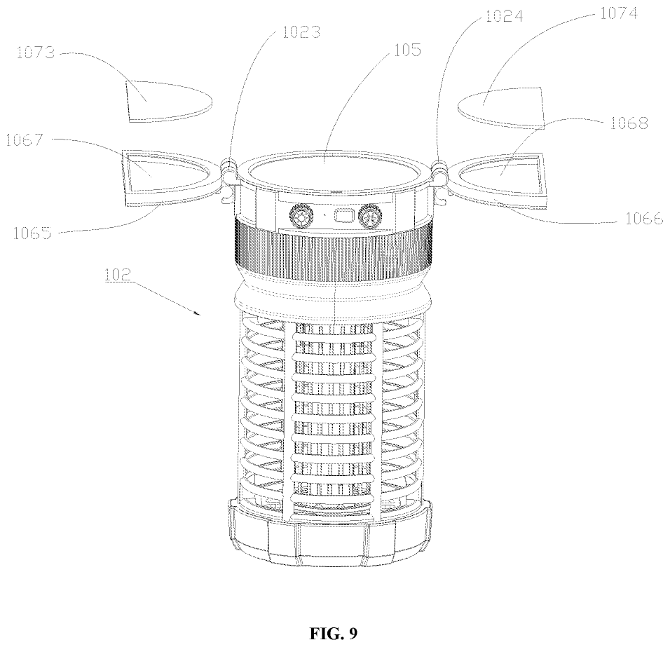

Referring to FIG. 9, the cover body 106 includes a third cover body 1065 and a fourth cover body 1066. The third cover body 1065 and the fourth cover body 1066 are respectively rotatably connected to the mounting shell 102 through a third rotating shaft mechanism 1023 and a fourth rotating shaft mechanism 1024. The third rotating shaft mechanism 1023 is horizontally arranged between the third cover body 1065 and the mounting shell 102, and the fourth rotating shaft mechanism 1024 is horizontally arranged between the fourth cover body 1066 and the mounting shell 102. The third cover body 1065 and the fourth cover body 1066 are respectively flipped and rotated up and down through the third rotating shaft mechanism 1023 and the fourth rotating shaft mechanism 1024, and jointly cover the upper end face of the mounting shell 102. The third cover body 1065 is provided with a fifth accommodating slot 1067. The second solar panel 107 includes a fifth solar panel 1073; the fifth solar panel 1073 is arranged in the fifth accommodating slot 1067; the fourth cover body 1066 is provided with a sixth accommodating slot 1068, and the second solar panel 62 includes a sixth solar panel 1074; and the sixth solar panel 1074 is arranged in the sixth accommodating slot 1068. When the third cover body 1065 and the fourth cover body 1066 are flipped to open, the first solar panel 105 and the second solar panel 107 can work simultaneously.

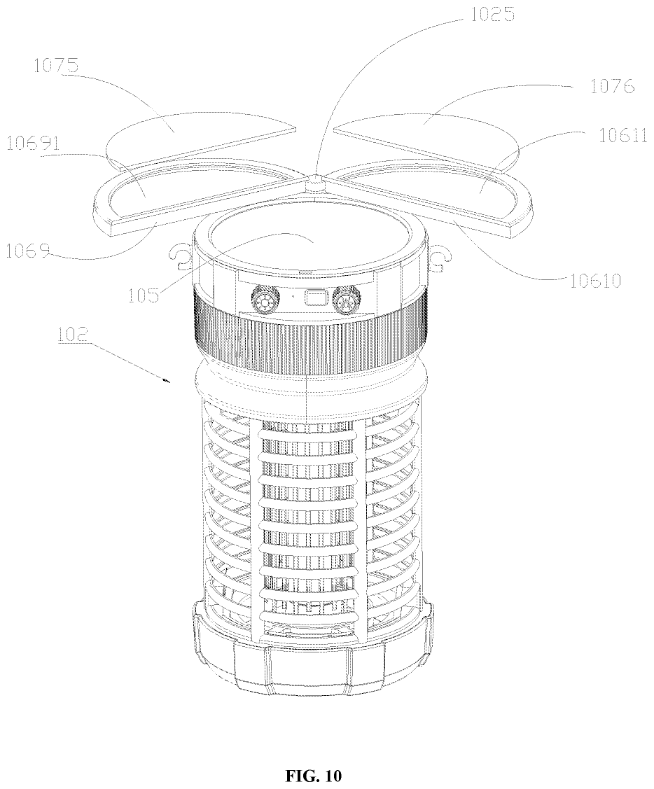

Referring to FIG. 10, the cover body includes a fifth cover body 1069 and a sixth cover body 10610. The fifth cover body 1069 and the sixth cover body 10610 are rotatably connected to the mounting shell 102 through a fifth rotating shaft mechanism 1025. The fifth rotating shaft mechanism 1025 is vertically arranged among the fifth cover body 1069, the sixth cover body 10610, and the mounting shell 102. The fifth cover body 1069 and the sixth cover body 10610 slide left and right through the fifth rotating shaft mechanism 1025 and jointly cover the upper end face of the mounting shell 102. The fifth cover body 1069 is provided with a seventh accommodating slot 10691. The second solar panel 107 includes a seventh solar panel 1075; the seventh solar panel 1075 is arranged in the seventh accommodating slot 10691; the sixth cover body 10610 is provided with an eighth accommodating slot 10611, and the second solar panel 107 includes an eighth solar panel 1076; and the eighth solar panel 1076 is arranged in the eighth accommodating slot 10611. When the fifth cover body 1069 and the sixth cover body 10610 slide relatively to rotatably open, the first solar panel 105 and the second solar panel 107 can work simultaneously.

In this embodiment, the second light-emitting unit 6 of the mosquito killer lamp 10 includes several LEDs 63; the LEDs 63 are arranged around the upper shell 103. The upper shell 103 is further provided with a transparent cover body 1082 which covers the LEDs. By means of the above structure, the LEDs can emit light of illumination through the transparent cover body, which can be used for night lighting.

In this embodiment, the mosquito killer lamp 10 further includes a handle portion 109. The handle portion 109 is rotatably connected to the mounting shell 102, and the handle portion 109 is configured to carry the mosquito killer lamp 10.

The present disclosure has the beneficial effects that the first light-emitting unit 5 in the mosquito killer lamp 10 adopts the LED tube 1. The LED tube 1 is configured to receive a power supplying signal VDDO sent by a power supplying module 2 and emit light for luring mosquitoes. By means of the above structure, compared with a traditional incandescent lamp or fluorescent lamp, the LED tube 1 has higher energy conversion efficiency. An LED lamp consumes less energy in the process of generating light and consumes less power, reducing the demand for energy, thus causing less burden on the environment.

One or more implementation modes are provided above in combination with specific contents, and it is not deemed that the specific implementation of the present disclosure is limited to these specifications. Any technical deductions or replacements approximate or similar to the method and structure of the present disclosure or made under the concept of the present disclosure shall fall within the scope of protection of the present disclosure.

1-4. (canceled)

5. A mosquito killer lamp, comprising:
a power supplying module, configured to output a power supplying signal;
a boost module, electrically connected to the power supplying module and configured to receive the power supplying signal and output a boost driving signal;
a mosquito killer unit, wherein the mosquito killer unit is electrically connected to the boost module and is configured to receive the driving signal, so that the mosquito killer unit kills mosquitoes;
a first light-emitting unit, electrically connected to the power supplying module and configured to receive the power supplying signal, wherein the first light-emitting unit comprises a first circuit board and a plurality of LEDs disposed on the first circuit board, wherein the plurality of LEDs are configured to receive the power supplying signal and emit light for luring mosquitoes;
a second circuit board, at least a part of the power supplying module and the boost module disposed on the second circuit board; and
a mounting shell, the mosquito killer unit, the power supplying module, the first light-emitting unit and the second circuit board installed on the mounting shell;
wherein the power supplying module further comprises a solar circuit and at least one solar panel electrically connected to the solar circuit; the at least one solar panel is configured to absorb solar rays and convert the solar rays into electric energy through the solar circuit; and
wherein the at least one solar panel comprises a first solar panel and a second solar panel, the first solar panel is disposed on the mounting shell; the first solar panel is electrically connected to the second circuit board; the mounting shell is provided with a cover body; the cover body is connected to the mounting shell; the cover body is provided with the second solar panel; and the second solar panel is electrically connected to the second circuit board.

6. The mosquito killer lamp according to claim 5, wherein the power supplying module comprises a first main control chip and a charging circuit; the charging circuit is electrically connected to a battery, and is configured to receive at least one of an external supply voltage and a battery voltage; the charging circuit is electrically connected to the first main control chip; a first output end of the charging circuit is configured to output an external power supply charging signal; a second output end of the charging circuit is configured to output a battery charging signal to the first main control chip; and the first main control chip is configured to output a charging control signal to a first control end of the charging circuit to control the external supply voltage charge the battery according to the external power supply charging signal and the battery charging signal.

7. The mosquito killer lamp according to claim 6, wherein the power supplying module comprises a switching circuit; the switching circuit is electrically connected to the charging circuit and the first main control chip; the switching circuit is configured to receive the external supply voltage and the battery voltage and output a supply voltage; the first main control chip is configured to receive the supply voltage; and when the charging circuit receives the external supply voltage, the switching circuit switches off inputting of the battery voltage of the charging circuit, so that when the external power supply performs charging, the battery stops supplying power.

8. The mosquito killer lamp according to claim 7, wherein the solar circuit is electrically connected to the first main control chip and the battery to output a solar charging signal to the first main control chip, the solar charging signal is also configured to charge the battery; and after the battery is fully charged, the first main control chip outputs a stop signal to control the solar circuit to stop charging.

9. The mosquito killer lamp according to claim 8, wherein the mosquito killer lamp further comprises a second light-emitting unit; the second light-emitting unit comprises a second light-emitting driving circuit; the second light-emitting driving circuit is electrically connected to the first main control chip to receive a working voltage and second control signal output by the first main control chip; and the second light-emitting unit is configured to achieve lighting.

10. The mosquito killer lamp according to claim 9, wherein the power supplying module further comprises a load switch circuit; the load switch circuit is electrically connected to the boost module, the first light-emitting unit, and the first main control chip; the load switch circuit is configured to receive a turn-on signal of the first main control chip and output a power supplying signal to the first light-emitting unit and the boost module respectively.

11. The mosquito killer lamp according to claim 10, wherein the mosquito killer lamp further comprises a first light-emitting driving circuit; the first light-emitting driving circuit is electrically connected to the plurality of LEDs; and the first light-emitting driving circuit is electrically connected to the load switch circuit and the first main control chip to receive the power supplying signal input by the load switch circuit and the first control signal input by the first main control chip and output a driving signal to drive the plurality of LEDs to emit light.

12. The mosquito killer lamp according to claim 11, further comprising an input protection circuit, wherein the input protection circuit is electrically connected to the external power supply and the charging circuit, and is configured to output the external supply voltage to the charging circuit; the input protection circuit is configured to protect the charging circuit; the charging circuit further comprises an indicator lamp module; and the indicator lamp module is electrically connected to the first main control chip and is configured to receive the working voltage of the first main control chip and display whether the charging circuit is in a normal working state.

13. The mosquito killer lamp according to claim 12, further comprising a stepless adjustment circuit and a light detection module, wherein the stepless adjustment circuit comprises a stepless adjustment device and a second main control chip; the stepless adjustment device is electrically connected to the second main control chip, and the second main control chip is electrically connected to the first main control chip; the stepless adjustment device is configured to perform a user operation to generate a wavelength adjustment signal and a brightness adjustment signal within a preset adjustment range; and the second main control chip is configured to receive the wavelength adjustment signal and the brightness adjustment signal and output an adjustment signal to the first main control chip, so that the first main control chip outputs a first control signal and a second control signal according to the adjustment signal, and the first light-emitting unit and the second light-emitting unit emit light within the preset adjustment range,
wherein the light detection module comprises a photoresistor and a resistance switch; the photoresistor is electrically connected to the first main control chip; the photoresistor is configured to receive a power signal output by the first main control chip, and the resistance switch is electrically connected to the second main control chip; when the resistance switch is turned on and the photoresistor detects corresponding light changes and reaches a preset resistance value, the photoresistor outputs a detection signal; and the first main control chip receives the detection signal and controls the mosquito killer lamp to be turned on.

14. (canceled)

15. The mosquito killer lamp according to claim 13, wherein the mosquito killer unit comprises a high-voltage power grid; the high-voltage power grid is configured to kill, under a high voltage, mosquitoes lured by the first light-emitting unit; the first main control chip, the charging circuit, the first light-emitting driving circuit, the switching circuit, the load switch circuit, the solar circuit, the input protection circuit, the stepless adjustment circuit, and the light detection module are all installed on the second circuit board; and the mounting shell is connected to the high-voltage power grid, the battery, the first light-emitting unit, and the second circuit board.

16. The mosquito killer lamp according to claim 15, wherein one end of the first circuit board is connected with an electrifying device; the electrifying device is connected with a first end cover; a pin is mounted on the first end cover; the pin is electrically connected to the electrifying device; and the other end of the first circuit board is connected with a second end cover, the first light-emitting unit further comprises a scattering structure and a transparent tube body; one end of the scattering structure is connected to the first end cover; the other end of the scattering structure is connected to the second end cover; one end of the transparent tube body is connected to the first end cover; the other end of the transparent tube body is connected to the second end cover; the plurality of LEDs are irregularly arranged on the circuit board; and the plurality of LEDs comprise a plurality of first LEDs with a wavelength of 365 to 380 nm and a plurality of second LEDs with a wavelength of 380 to 400 nm.

17. (canceled)

18. The mosquito killer lamp according to claim 16, wherein the first light-emitting unit is detachably connected to the mounting shell; the mounting shell comprises an upper shell and a base; the upper shell is provided with a first clamping slot and a first fixing member; the first fixing member is provided with a mounting hole; the pin is detachably plugged into the mounting hole; the first end cover is detachably plugged into the first clamping slot; the base is provided with a second clamping slot and a second fixing member; and the second end cover is detachably plugged into the second clamping slot through the second fixing member.

19. The mosquito killer lamp according to claim 18, further comprising a lampshade, wherein an upper end of the lampshade is connected to a bottom of the upper shell, and a lower end is connected to a top of the base; the first light-emitting unit and the high-voltage power grid are both arranged in the lampshade; the high-voltage power grid is arranged around the first light-emitting unit; one end of the high-voltage power grid is connected to the upper shell, and the other end of the high-voltage power grid is connected to the base; the base is provided with a killed mosquito opening and a bottom cover; the bottom cover is detachably connected to the base; when the high-voltage power grid kills mosquitoes, the mosquitoes killed by the high-voltage power grid enter and fall onto the bottom cover through the killed mosquito opening.

20. The mosquito killer lamp according to claim 19, wherein the second light-emitting unit of the mosquito killer lamp further comprises a plurality of third LEDs; the plurality of third LEDs are arranged around the upper shell; the upper shell is further provided with a transparent cover body; the transparent cover body covers the plurality of third LEDs; the mosquito killer lamp further comprises a handle portion; the handle portion is rotatably connected to the mounting shell; and the handle portion is configured to carry the mosquito killer lamp.

21-25. (canceled)

26. A mosquito killer lamp, comprising:
a power supplying module, configured to output a power supplying signal;
a boost module, electrically connected to the power supplying module and configured to receive the power supplying signal and output a boost driving signal;
a mosquito killer unit, wherein the mosquito killer unit is electrically connected to the boost module and is configured to receive the driving signal, so that the mosquito killer unit kills mosquitoes; and
a first light-emitting unit, electrically connected to the power supplying module and configured to receive the power supplying signal,
wherein the first light-emitting unit comprises a first circuit board and a plurality of LEDs disposed on the first circuit board, wherein the plurality of LEDs are configured to receive the power supplying signal and emit light for luring mosquitoes; the plurality of LEDs are irregularly arranged on the circuit board; and the plurality of LEDs comprise a plurality of first LEDs with a central wavelength ranging from 365 to 380 nm and a plurality of second LEDs with a central wavelength ranging from 380 to 400 nm.

27. The mosquito killer lamp according to claim 5, wherein the first solar panel is disposed on an upper end surface of the mounting shell.

28. The mosquito killer lamp according to claim 27, wherein a first accommodating slot is formed in the upper end surface of the mounting shell; an upwards protruding electrical contact is arranged on a bottom of the first accommodating slot; the first solar panel is arranged in the first accommodating slot; and the first solar panel is electrically connected to the battery and the circuit board through the electrical contact, wherein the mounting shell is rotatably connected with a cover body; the cover body is provided with a second accommodating slot; the solar panel module comprises a second solar panel; the second solar panel is arranged in the second accommodating slot; and the second layer of solar panel is electrically connected to the circuit board and the battery.

29. The mosquito killer lamp according to claim 28, wherein the cover body is flipped and rotated with the mounting shell through a rotating shaft mechanism; the rotating shaft mechanism is horizontally arranged between the cover body and the mounting shell, and the cover body is flipped up and down to cover the upper end face of the mounting shell through the rotating shaft mechanism; the cover body is provided with the second accommodating slot; and when the cover body is flipped to open, the first solar panel and the second solar panel work simultaneously.
